(19) United States
(12) Patent Application Publication
(10) Pub. No.: US 2011/0101938 A1
(43) Pub. Date: May 5, 2011

(54) ADAPTIVE-GAIN STEP-UP/DOWN SWITCHED-CAPACITOR DC/DC CONVERTERS

(75) Inventors: Dongsheng Ma, Tucson, AZ (US); Inshad Chowdhury, Tucson, AZ (US)

(73) Assignee: The Arizona Board of Regents on Behalf of The University of Arizona, Tucson, AZ (US)

(21) Appl. No.: 12/744,011

(22) PCT Filed: Nov. 20, 2008
(86) PCT No.: PCT/US2008/084182

§ 371 Date: Dec. 1, 2010

Related U.S. Application Data
(60) Provisional application No. 61/004,095, filed on Nov. 21, 2007.

(51) Int. Cl. H02M 3/07; G05F 1/46

(52) U.S. Cl. 323/282

(57) ABSTRACT

A switched-capacitor DC-DC converter has a reconfigurable power stage with variable gain ratio and/or interleaving regulation for low ripple voltage, fast load transient operation, variable output voltage and high efficiency. Since the power stage has multiple switches per capacitor, the converter exploits reconfigurable characteristics of the power stage for fast dynamic control and adaptive pulse control for tight and efficient voltage regulation.

### REFERENCE TO RELATED APPLICATION

The present application claims the benefit of U.S. Provisional Patent Application No. 61/004,095, filed Nov. 21, 2007, whose disclosure is hereby incorporated by reference in its entirety into the present disclosure.

### FIELD OF THE INVENTION

The present invention is directed to DC/DC converters and more particularly to such converters using switches and capacitors in a reconfigurable manner.

### DESCRIPTION OF RELATED ART

In recent years, multi-function portable devices have been proliferating over the electronic industry. The multiple functional modules in such a device are usually optimized at different power supply levels. To achieve a long battery runtime and low system profile, efficient and compact power conversion circuits become essential in these systems.

Conventional switching converters provide high power efficiency, but suffer from severe electromagnetic interference (EMI) noise and bulky system profile, due to the employment of inductive components. Thus, switched-capacitor (SC) DC-DC converters emerge as an alternative solution to integrated power conversion circuit designs. The most commonly used voltage conversion for SC converters is step-up conversion.

Classic examples include Dickson charge pumps and cross-coupled voltage doublers. The difficulty of implementing step-down SC converters lies in the fact that it is much harder to maintain high efficiency than in their step-up counterparts. A linear regulator does not suffice under this scenario when the dropout voltage is large between the output and the input, due to the inherently poor efficiency. However, as low power operation gets ever more critical in VLSI systems, step-down voltage conversions are in high demand. Thus, a need exists in the art for power-efficient low-EMI step-up and/or step-down SC converters.

In addition to the concerns on the converters' topologies, new requirements on system performances also arise. As more and more self-powered portable devices are invented, power efficiency in a SC converter can hardly stay high with a fixed conversion gain ratio, which is defined as the ratio of the output voltage to the input supply voltage of a DC-DC converter. The converter should have excellent line regulation to ensure the reliability when the power source is very unstable. More preferably, it should have adaptively adjustable conversion gain ratio to maintain high efficiency. On the other hand, the output of a converter should be able to promptly respond to fast and frequent load changes.

In some applications, the output voltage is required to be variable to dynamically optimize the instantaneous power and speed of load applications. One perfect example can be found in dynamic voltage scaling (DVS) applications. In this sense, excellent load transient response and voltage tracking capability are paramount to new power converter designs.

Any SC DC-DC converter performs by charging and discharging the pumping capacitor(s). After the discharge period, the voltage across the pumping capacitor decreases as charge is drained from it by the output load. As a result, at the beginning of the charging period, the voltage across the capacitor suddenly increases. This results in a sudden inrush of current generated in the input power line and propagated into the capacitor. Now, the power source is connected to the converter via wires which induce parasitic inductance. Sudden increase in current creates voltage spikes across the wire which is then coupled into the power source, leading to large switching noise. If the same power source is used by other parts of the system, this input noise gets coupled to those parts as well.

The charge and discharge phenomenon of the pumping capacitor(s) also causes an output ripple in a conventional SC converter. During the charging phase(s), the output load drains current from the output capacitor, reducing the voltage across the capacitor. During the discharging phase(s), the charge stored in the pumping capacitor(s) is discharged to the output load and charges up the output capacitor, increasing the voltage across the capacitor.

To facilitate a low-noise, fast-transient, efficient SC DC-DC converter, we first examine the major drawbacks in the prior art. FIG. 1A depicts a typical CMOS cross-coupled voltage doubler 100. FIG. 1B shows the timing signals and the input current and output voltage as functions of time. Because the pumping capacitor C connected to V₀ is not recharged until the next half clock cycle begins, V₀ drops during most of each half clock cycle. A large voltage ripple (ΔV₀₂) is observed at V₀ because the circuit cannot respond to this change until the current half clock cycle expires. This affects the transient response and leads to large variation and noise at the regulated power line. In addition, because M₁ and M₂ are required to be turned on in two non-overlapping phases alternately, the input current of power supply Vᵢₙ is discontinuous with a large ripple. This current ripple causes substantial switching noise, which will then be coupled into the entire IC chip, through the power supply metal lines and the substrates of power transistors.

To overcome the above drawbacks, as shown in FIG. 2, an interleaving SC power converter 200 introduces two circuits 202, 204 based on the circuit 100 of FIG. 1A, thus introducing four effective regulation sub-cells and operating each of them with 90° phase shift. Their performance comparison is given in FIG. 3. FIG. 4A shows the clock signals and the interconnection among the capacitors during each clock phase. From the circuit connection and clock waveform, it is easy to identify that this is in fact a parallel connection of two cross-coupled voltage doublers 202, 204 with 90° phase difference. By introducing 90° phase overlapping between neighboring CP cells, the input current becomes continuous and has low ripples. At any instant when two clock signals are HIGH, the pumping capacitors associated with the other two complementary clocks are charged to V_{IN}. For example, when φ₁ and φ₄ are HIGH, the nodes 1 and 4 become HIGH. The transistors M_{5N} and M_{2N} are thus turned on, and the pumping capacitors Cp3 and Cp2 are charged to V_{IN}. This ensures a faster transient response than the previous design. Hence, the new architecture overcomes drawbacks in the circuit of FIG. 1A. However, this topology has a fixed conversion ratio as a doubler.

A SC power converter's power stage must be reconfigurable with variable conversion GRs (gain ratios) to achieve high efficiency. Very few works have been reported in this area. Although the prior art can provide multiple GRs, the known power converters suffer from large inrush input current, high output ripples and slow transient response. The regulation scheme is illustrated in FIG. 4A. Here we use GR=3/2 as one example. The converter's operation can be described in two phases—Phase 1 and 2. In Phase 1, the pumping capacitors C_{P1} and C_{P2} are connected in series across V_{IN}. If C_{P1}=C_{P2}, the voltage across each capacitor is then pre-charged to V_{IN}/2. During Phase 2, C_{P1} and C_{P2} are connected in parallel between V_{IN} and V_{OUT}, and as a result, C_{OUT} is charged to 3/2V_{IN} (=V_{IN}+V_{IN}/2). The separation of the charge and discharge actions leads to large current and voltage ripple problems as previous examples. Techniques such as power stage are not applicable here, due to high number of required switches and capacitors. Also note that the capacitor C_{P3} remains idle during the entire operation.

A topology that has multiple gain ratios is known in the art. However, to provide the same advantage of interleaving for that topology, the number of switches and capacitors needs to be doubled.

### SUMMARY OF THE INVENTION

Thus, a need exists in the art for an improved topology with multiple gain ratios, reconfigurable power stage and/or interleaving regulation capability, but with fewer switches.

To achieve the above and other objects, the present invention is directed to a power stage for a switched capacitor (SC) DC-DC converter comprising a number of capacitors, power switches and a controller. It can be flexibly configured to supply both step-up and step-down voltages from a power source. Unlike a traditional SC power stage, this invention uses switch and capacitor reconfiguration with interleaving regulation to reduce input noise, output ripple and improve loop-gain bandwidth.

The invention can be directly applied to switched-capacitor DC-DC power converters. It has general significance on future high performance reconfigurable or variable-output power supply designs.

The subject of this invention has the following advantages over the present technology:
Lower Input Noise
Lower Output Ripple
Higher Bandwidth
Variable Gain Ratio
Variable Output Voltage
Higher Efficiency

The present invention is directed, in at least some embodiments, to a new integrated reconfigurable switched-capacitor DC-DC converter. The converter employs a power stage with multi-phase (e.g., three-phase) interleaving regulation for low ripple voltage and fast load transient operations. It effectively exploits the characteristics of the power stage reconfiguration for fast gain-ratio control and adaptive pulse control for tight and efficient voltage regulation. The converter exhibits excellent robustness, even when one of the CP cells fails to operate. A fully digital controller is employed with a hysteretic control algorithm. It features deadbeat system stability and fast transient response. The converter was designed with TSMC 0.35-μm CMOS N-well process. With an input voltage ranging from 1.5-3.3 V, the converter achieves variable step-down and step-up voltage conversion with an output from 0.9-3.0 V with a maximum efficiency of 92%. The research provides an effective solution for fast-transient low-ripple integrated power converter design.

In at least some embodiments, the present invention implements a SC power converter with an adaptive gain-pulse control. The converter adaptively employs a novel step up-down reconfigurable SC power stage with adjustable conversion gain ratio and variable power pulses for efficient operation under a wide input range. The dual-loop control ensures fast transient response as well as excellent line and load regulations.

A new integrated SC DC-DC converter with multiple phase interleaving regulation has been proposed. It has better input noise, lower ripple and high efficiency. The gain can be dynamically varied.

The present invention is broadly applicable to energy-efficient devices for both low-power and high-power applications, the latter including automotive uses and electronic appliances.

U.S. Pat. No. 7,190,210 B2, titled “Switched-capacitor power supply system and method,” teaches a method to group capacitors into different phase and block structures as the building block of the SC system. A control circuit switches each phase between charging and discharging states devised to supply one or more loads with controlled power. The present invention takes a different approach in grouping the capacitors into different phase and block structure that renders superior performance and cost advantage. The detail of which is described next. The definition of phase used in that reference is different from the definition used in the present invention. However, to provide a more clear description, we use the term “phase” in this discussion as it is used in the U.S. Pat. No. 7,190,210.

The structure of the grouped capacitor block in the patent that is used in step-down DC-DC conversion is given in FIG. 3 of that reference. Another version of the block that is capable of both step-up and step-down DC-DC conversion is given FIG. 15 of that reference. Since the step-up/down version is more relevant to our invention; we draw the comparison with the block described in FIG. 15. Also, in FIG. 15 the switch P3 and P4 are used in parallel performing the same functionality of connecting the bottom plate capacitor to ground. Therefore, they are regarded as single switch in our discussion. As shown in FIG. 15 of that reference, each block consists of four switches and one capacitor with the exception of first block that has five switches. The structure of the SC circuit allows the capacitors to get charged in series and discharge in parallel for step-down conversion and get charged in parallel and discharge in series for step-up conversion. It also has the capability to disable one the blocks to attain different gain ratios (GR). With N number of blocks, the invention in the patent can achieve 2N+1 GRs. On the other hand, in our invention, each block consists of six switches and one capacitor with no exception. The structure of the SC block allows for different combination of series and parallel charging and discharging. This results in higher number of achievable GRs. Since more GR correspond to higher efficiency of the system, our invention performs better compared to the invention described in that reference.

The invention in that reference also employs an interleaving technique as described in FIG. 11. FIG. 11 shows the timing diagram of the control signal of M phase power stage. Each phase consists of the N number of blocks. Therefore, the total blocks used in the system are M×N. In our case, no new phases are introduced to achieve interleaving operation. It is achieved through structural changes within the phase. Therefore, to achieve the performance of an M phase interleaving regulation, our invented power stage needs only M blocks instead of M×N blocks that are needed in that reference. This saves in silicon area as the number of switches and capacitors in the system reduce. Thus, our invention provides cost advantage and simplifies the design.

U.S. Pat. No. 6,055,168, titled “Capacitor DC-DC converter with PFM and Gain hopping,” teaches a structure and method for converting unregulated DC voltages to regulated DC voltages using pulse frequency modulation (PFM) and a switched capacitor array capable of multiple step-up/down gains, where gain selection is based on the output voltage. The power stage i.e. the switched capacitor array of the converter operates in traditional charge-discharge mechanism which suffers from higher input noise, output ripple and slow transient response than that of a power stage that employs interleaving technique. Our invented power stage provides improves upon that power stage by employing a novel interleaving technique that is discussed next.

The power stage presented in that reference consists of three capacitors and fifteen switches to achieve the seven GRs (gain ratios). They operate in two phases: the charge phase where all the capacitors get charged from the input and the discharge phase where all the capacitors get discharged at the output. These converters have large input noise as the voltage across the capacitors changes suddenly and large ripple voltage at the output as no capacitor provides charge at the output during the charge phase. To improve the performance, two such converters can be placed in parallel and operated in an interleaving manner so that there is continuous charging at the input and discharging at the output. This greatly reduces the input noise and output voltage ripple. However, this would also mean doubling the number of capacitors (6) and switches (30). In at least some embodiments, the invention proposed here achieves this performance with only three capacitors and eighteen switches using the three phase cyclic charge transference. In this mechanism, the switches are turned on/off in a way so that at least one capacitor gets charged by the input and one capacitor gets discharged at the output during each phase. The other capacitor is used either to provide certain GR or if not needed, it gets charged from the input as well. The capacitors exchange the positions in the next phase. The process repeats one more time after which the capacitors are back at their initial position. This way, after a full three phase clock period, each capacitor is at least charged once by the input and discharged once at the output. This continuous charging and discharging renders the benefits of the interleaving operation with a reduced number of capacitors and switches.

The present invention can be implemented as an integrated solution or as a discrete solution. For example, the switches can be implemented with CMOS, BJT, or any other discrete component that can be used as a switch. Also, the capacitors can be implemented on-chip or off-chip.

### BRIEF DESCRIPTION OF THE DRAWINGS

A preferred embodiment will be disclosed with reference to the drawings, in which:

FIG. 1A is a circuit diagram of a cross coupled voltage doubler according to the prior art;

FIG. 1B is a set of plots showing the timing signals, the input current, and the output voltage of the voltage doubler of FIG. 1;

FIG. 2 is a circuit diagram of a multiphase voltage doubler according to the prior art;

FIG. 3 is a set of plots showing a performance comparison between the voltage doublers of FIGS. 1 and 2;

FIG. 4A shows the clock signals and capacitor connections for the voltage doubler of FIG. 2;

FIG. 4B shows the clock signals and capacitor connections for the voltage doubler according to the preferred embodiment;

FIG. 5 is a circuit diagram showing a three-capacitor power stage according to the preferred embodiment;

FIGS. 6A and 6B show the timing signals and capacitor connections, respectively, for various gain ratios in the power stage of FIG. 5;

FIG. 7 is a circuit diagram showing a generalization of the power stage of FIG. 5 to N capacitors and 6N switches;

FIG. 8 is a circuit diagram showing a three-phase non-overlapping clock generator;

FIG. 9 is a set of plots showing the clock signals generated by the clock generator of FIG. 8;

FIG. 10 is a circuit diagram showing a circuit for automatic substrate switching;

FIG. 11 is a circuit diagram showing a level shifting circuit for providing clock signals;

FIG. 12 is a circuit diagram showing a ring oscillator A/D converter;

FIG. 12A is a circuit diagram showing a closed loop SC DC-DC converter;

FIG. 13 shows a sensor circuit;

FIG. 13A shows adaptive pulse control;

FIG. 14 is a plot showing output power versus efficiency;

FIGS. 15A and 15B are plots showing input current for the conventional SC power stage and the preferred embodiment, respectively;

FIGS. 16A and 16B are plots showing output ripple voltage for the conventional SC power stage and the preferred embodiment, respectively; and

FIGS. 17A and 17B are plots showing start-up transient response for the conventional SC power stage and the preferred embodiment, respectively.

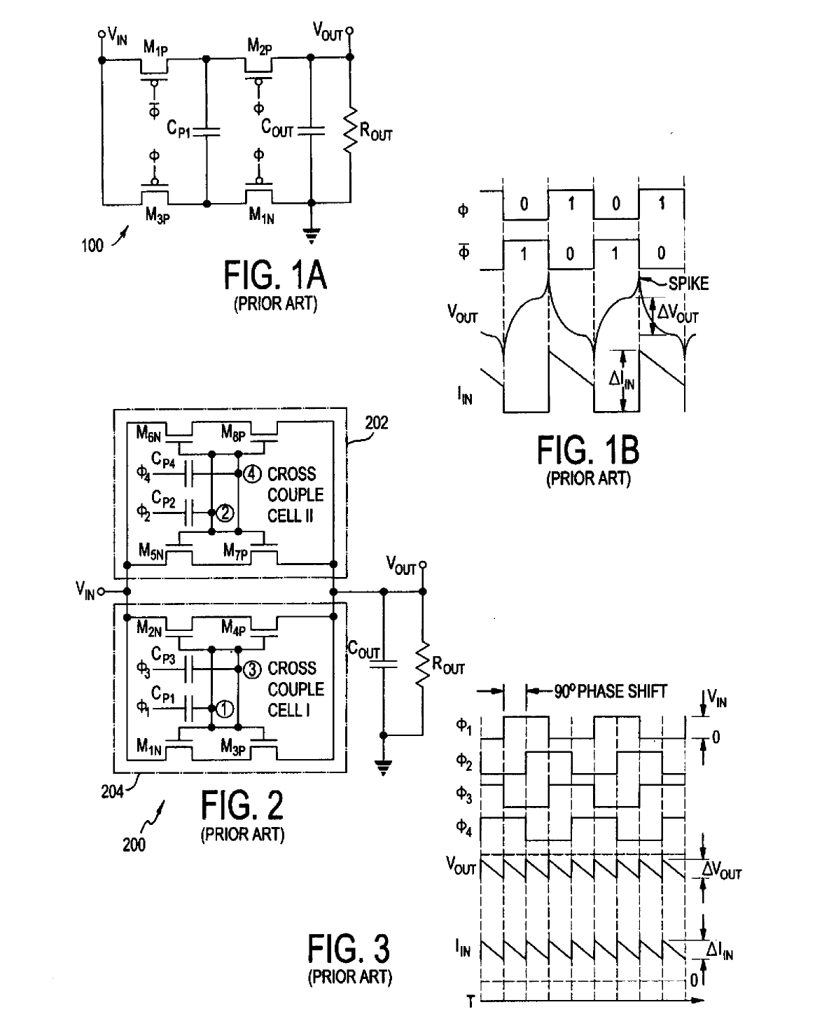

### DETAILED DESCRIPTION OF THE PREFERRED EMBODIMENT

A preferred embodiment will be set forth in detail with reference to the drawings, in which like reference numerals refer to like elements throughout.

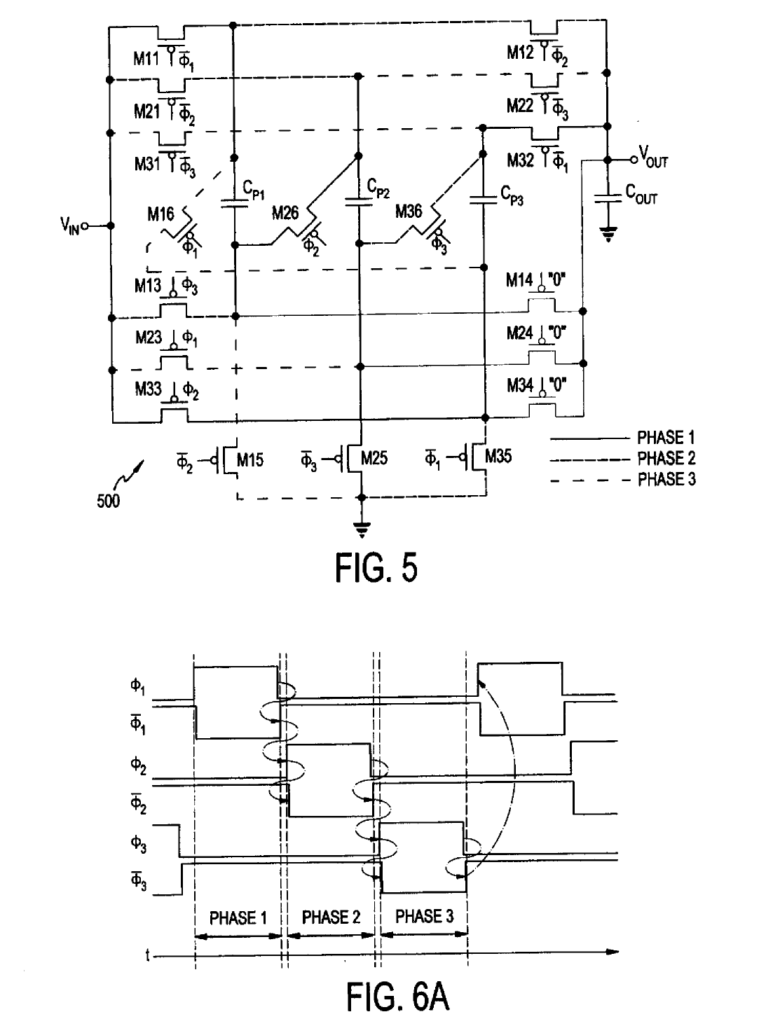

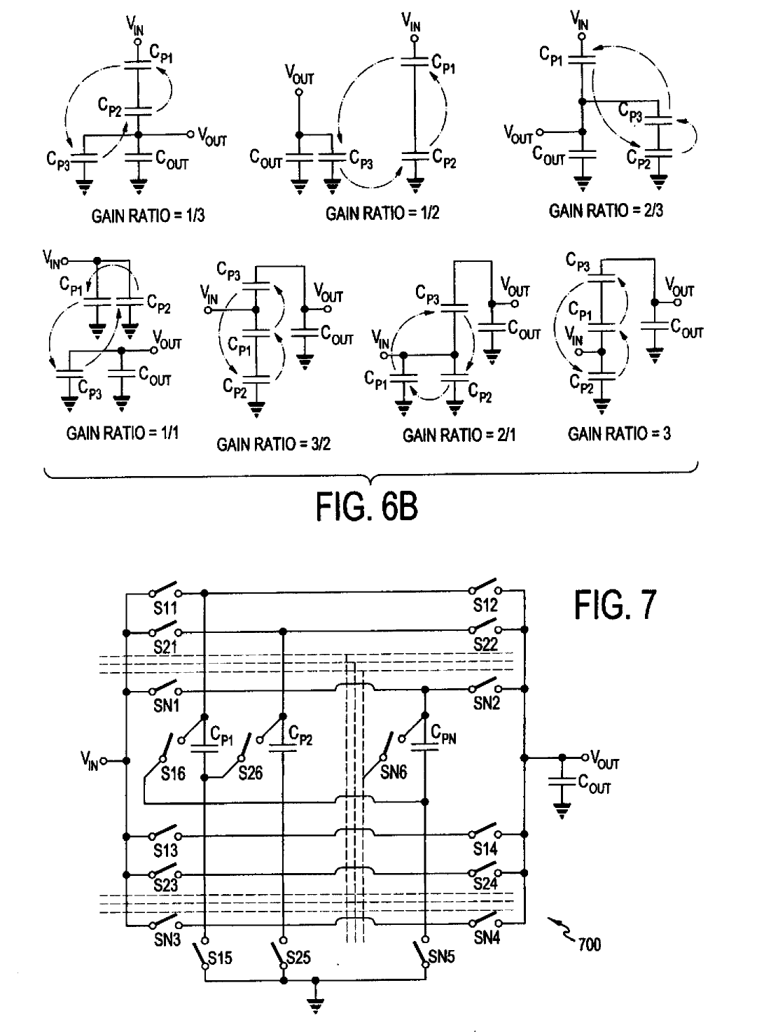

The preferred embodiment is directed to a new topology that provides the same advantage but using only half the switches. The preferred embodiment uses three capacitors and eighteen switches, although that number is illustrative rather than limiting. FIG. 5 shows the complete power stage 500. Using the on/off characteristics of a switch, the switch array can be configured to give six different gain states: 1/3, 1/2, 2/3, 1, 3/2, 2, and 3. The task is accomplished using a three-phase clock. The clock signals are routed according to the desired gain. The clock signals and capacitor configuration for all the gain settings are shown in FIGS. 6A and 6B, respectively. In each phase of the clock, at least one capacitor gets charged from the input, while one capacitor is discharged at the output. The other capacitor is used either to provide certain gain configuration or, if not needed, it gets charged from the input as well. In the following phases, the capacitors exchange their places. This way, after a full clock period, each capacitor has been once charged by the input and discharged at the output. This way, charge gets transferred from input to output and depending on the capacitor. configurations, a certain voltage gain is achieved.

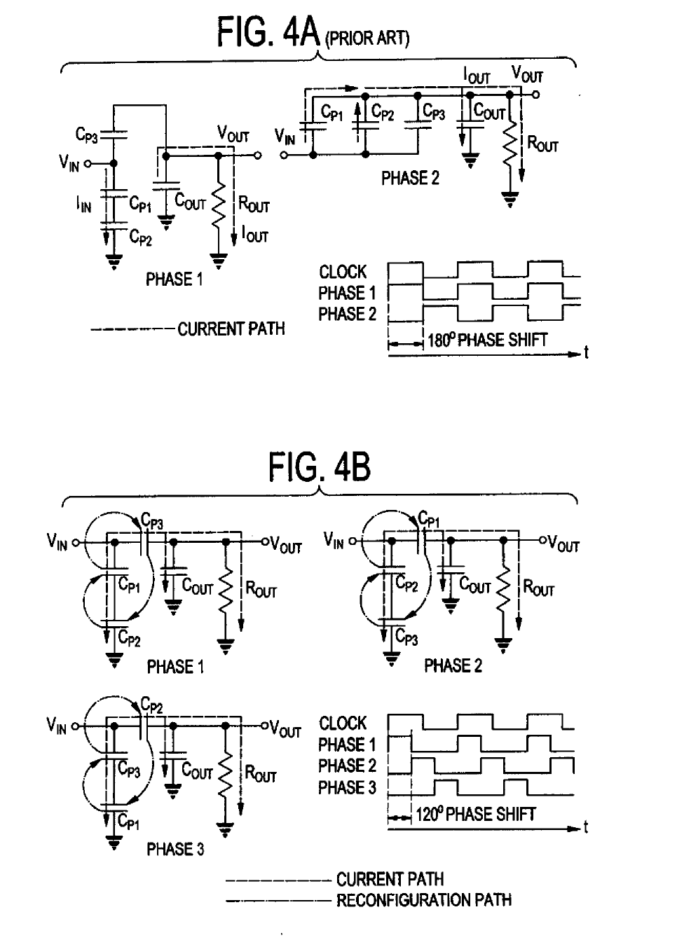

To solve the aforementioned problems regarding variable gain, we propose to operate the pumping capacitors alternatively by reconfiguring the power stage in an interleaving manner. The operation mechanism is demonstrated in FIG. 4B. In this case, the proposed converter is regulated in three phases—Phase 1, 2 and 3. Each phase clock has 120° phase difference from the others, as depicted in FIG. 4B. During Phase 1, the converter follows exactly the same operation as the circuit described in FIG. 4A. However, in Phase 2, instead of keeping C_{P3} idle, the capacitors exchange the positions: C_{P1} is connected between V_{OUT} and V_{IN} and delivers charge to C_{OUT}, while C_{P2} and C_{P3} are pre-charged to V_{IN}/2. Similarly, in Phase 3, C_{P2} delivers charge to C_{OUT} while C_{P1} and C_{P3} are pre-charged to V_{IN}/2.

As results, there always exist two charged capacitors that are ready for the coming clock phases' power delivery. This continuous charging operation leads to continuous input charge current and thus low in-rush current ripples. Meanwhile, there is always one capacitor powering C_{OUT} at any instant, leading to a continuous output discharge current. This reduces the output voltage ripples and ensures instant load transient response.

The preferred embodiment provides a new power stage architecture to facilitate the interleaving regulation mechanism and to adapt to line/load variations as well as system demands. The circuit forms a switch-capacitor array. Each of the capacitors in the array is associated with six switches, which can flexibly connect the plates of the capacitor to either V_{IN} or V_{OUT} or another capacitor. For example, the top plate of C_{P1} can be connected to V_{IN} by S₁₁, or to V_{OUT} by S₁₂, or to the bottom plate of C_{PN} by S₁₆. Meanwhile, the bottom plate of C_{P1} can be connected to V_{IN} by S₁₃, or to V_{OUT} by S₁₄, or to the top plate of C_{P2} by S₂₆, or to by S₁₅.

Although this principle is shown with three capacitors and eighteen switches, the same principle can be applied either to fewer capacitors using fewer switches or to more capacitors with more switches (that is, N capacitors and 6N switches). A generalized power stage is shown in FIG. 7 as 700. In general, with N pumping capacitors and 6N switches, the converter can achieve 4N-5 different GRs, with the options of 1 to N interleaving phases. For the cases of step-down conversions, the GR can be represented as i/j, where j=1, 2, . . . , N, and j+1, . . . , N. For the cases of step-up conversions, the GR can be represented as i/j, where j=1, 2, . . . , N, and i=1, 2, . . . , j. In practice, this generic architecture can be simplified according to specific applications, so that the number of the associated switches can be reduced. For example, if only step-down conversions are needed, the switches Sᵢ₃ in FIG. 7 can be eliminated, where i=1, 2, . . . , N. The SC converter then offers 2N-2 step-down GRs with N capacitor and 5N switches. Similarly, the switches Sᵢ₄ can be removed in the step-up conversions to provide 2N-3 step-up GRs with N capacitors and 5N switches, where i=1, 2, . . . , N. Using two capacitors decreases the complexity of the power stage; however it can provide only three gain settings, which reduces the range of high conversion efficiency. On the other hand, more capacitors with more switches provide more gain settings, resulting in increased range of high conversion efficiency. But it also increases the cost as it requires more silicon area.

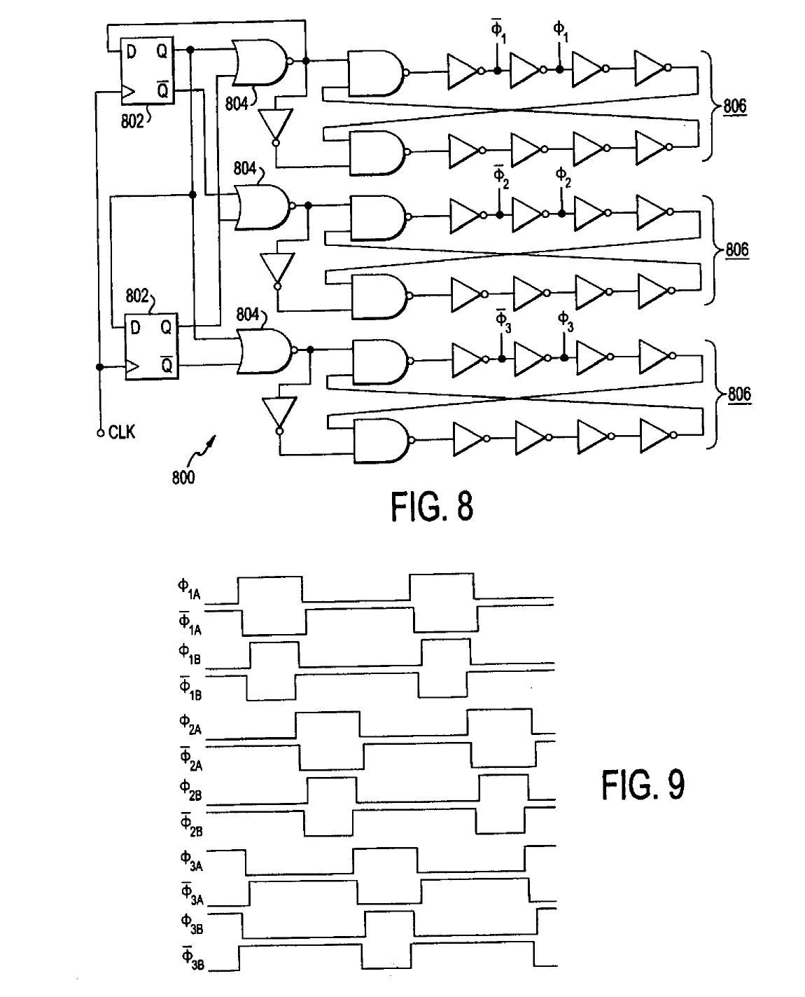

FIG. 8 shows a clock generator 800. The clock generator has a first stage with flip-flop circuits 802, a second stage with NOR gates 804, and a third stage with pulse-generating circuits 806. The resulting non-overlapping clock signals are shown in FIG. 9.

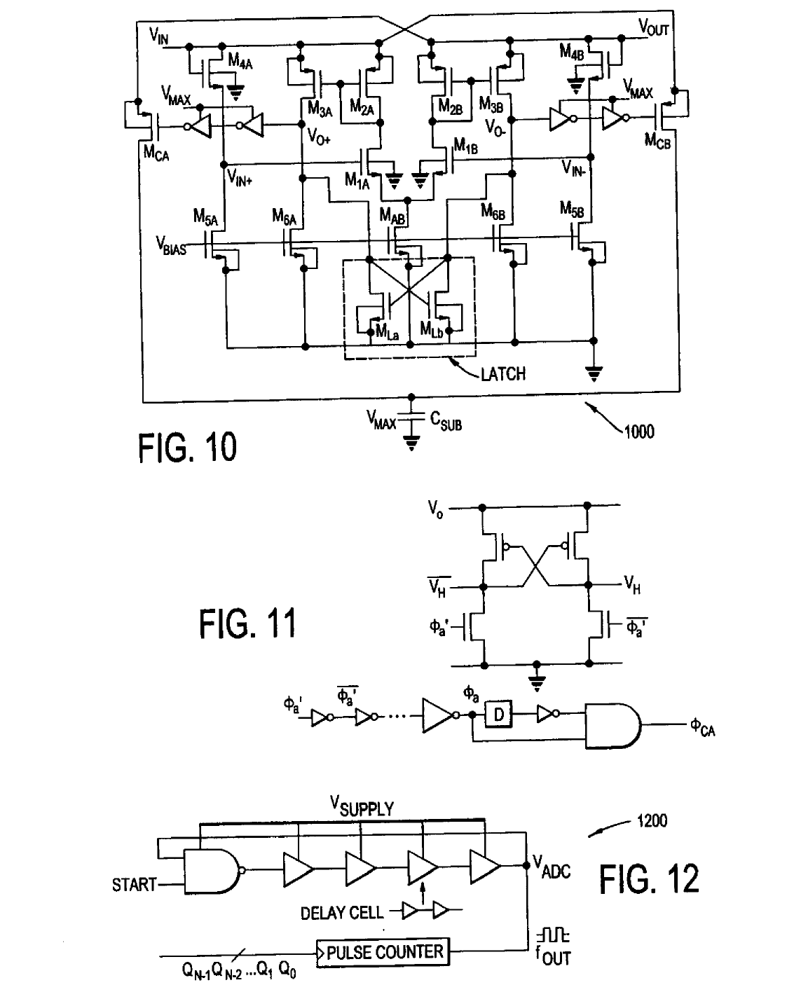

FIG. 10 shows a circuit 1000 for automatic substrate switching. FIG. 11 shows a circuit 1100 for level shifting for providing clock signals.

The output signal of the converter is an analog voltage. In order to implement the digital control, an analog to digital (A/D) converter is required to convert the analog output voltage into digital signals. A traditional A/D converter is not preferred because it occupies too much silicon area, consumes much power and is very sensitive to noise. Recently, a ring-oscillator and delay-line based A/D converter has been reported. Compared with traditional designs, it is more area- and power-efficient. Since both of them choose digital logic gates as building blocks, it has larger noise margin and is more robust than analog A/D converters.

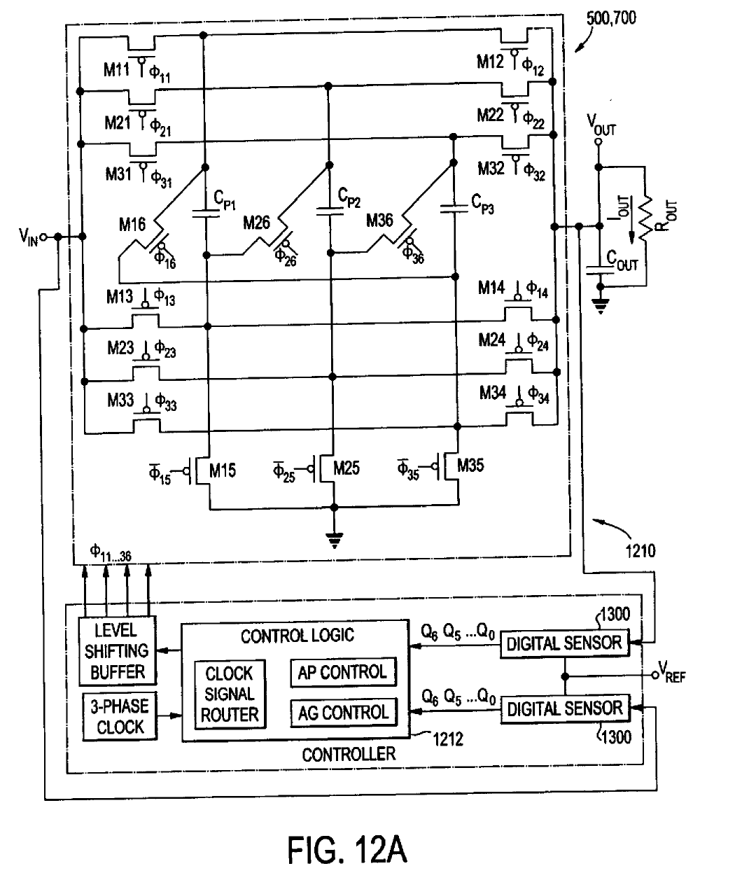

Compared to delay-line based design, the ring oscillator based A/D converter is even more area efficient because the delay elements can be re-used even within a single switching clock cycle. The preferred embodiment uses a new ring-oscillator based A/D converter, shown in FIG. 12 as 1200. The circuit includes of one NOR gate 1202, four delay cells 1204 and one pulse counter 1206. Each delay cell 1204 simply includes two inverters. The pulse counter 1206 is an asynchronous positive edge triggered N-bit counter. Note that the NOR gate 1202 and the delay cells 1204 are powered by V_{OUT}, which is the output of the SC DC-DC converter. When the Start signal is HIGH, the loop will keep in a static state, and the outputs of the delays cells remain Low. Otherwise, the loop oscillates, and a series of pulses is generated at V_{ADC} with an oscillating frequency of f_{OUT}. By examining Q_{N-1} . . . Q₀ at the output of the counter, the voltage V_{OUT} is calculated.

The adaptive gain/pulse control has two control loops. One determines the gain ratio based on the input voltage and the reference voltage (AG, or adaptive gain, control). The other determines the frequency of charge transfer operation based on the reference voltage (AP, or adaptive pulse control). FIG. 12A shows the closed loop system block diagram 1220 of the proposed SC DC-DC converter. It includes three major blocks: dual-loop digital sensors 1300 (described below), AP/AG controller 1212 and the reconfigurable power stage 500, 700. The converter employs dual-loop control to achieve effective regulations on both input and output voltages. The feed-forward loop compares V_{IN} with V_{REF} to determine the optimal GR, while the feedback loop detects the error difference between V_{OUT} and V_{REF} to generate the duty ratio of the converter in the following ways: When V_{OUT}>V_{REF}, the controller disables the control clocks and stops the charge delivery; when V_{OUT}<V_{REF}, the controller generates the duty ratio according to the instant GR. However, if V_{OUT}<<V_{REF} for four consecutive switching cycles, the GR will be increased by one level. If the condition sustains, more pulses would be assigned with even higher GRs. In addition, the three-phase control clock generation is illustrated in FIG. 8.

The GR determination can be done in many different ways. As the system is controlled by a digital controller, A/D converters are necessary to convert the analog V_{IN}, V_{OUT} and V_{REF} to digital signals. Here we adopt a ring oscillator based A/D converter topology over the conventional because of its smaller area, higher power efficiency and larger noise margin. The circuit schematic is shown in FIG. 12, described above. It includes one NOR gate, four delay cells and an N-bit pulse counter. The Start signal is “0” effective meaning when this signal is low, the loop starts to oscillate and a series of pulses are generated at V_{ADC} with an oscillation frequency of f_{OUT}. The pulse counter counts the number of pulses and shows the result in an N-bit binary data Q_{N-1} . . . Q₀. The relationship between the input voltage V_{SUPPLY} and digital clock frequency follows,

$${f}_{OUT} = \frac{{β ( {V}_{SUPPLY} - {V}_{T} )}^{2}}{2 {kn}_{stage} {C}_{L} {V}_{SUPPLY}} ,$$

where k and β are process parameters, n_{stages} is the number of stages and C_{L} is the load capacitor for one delay cell.

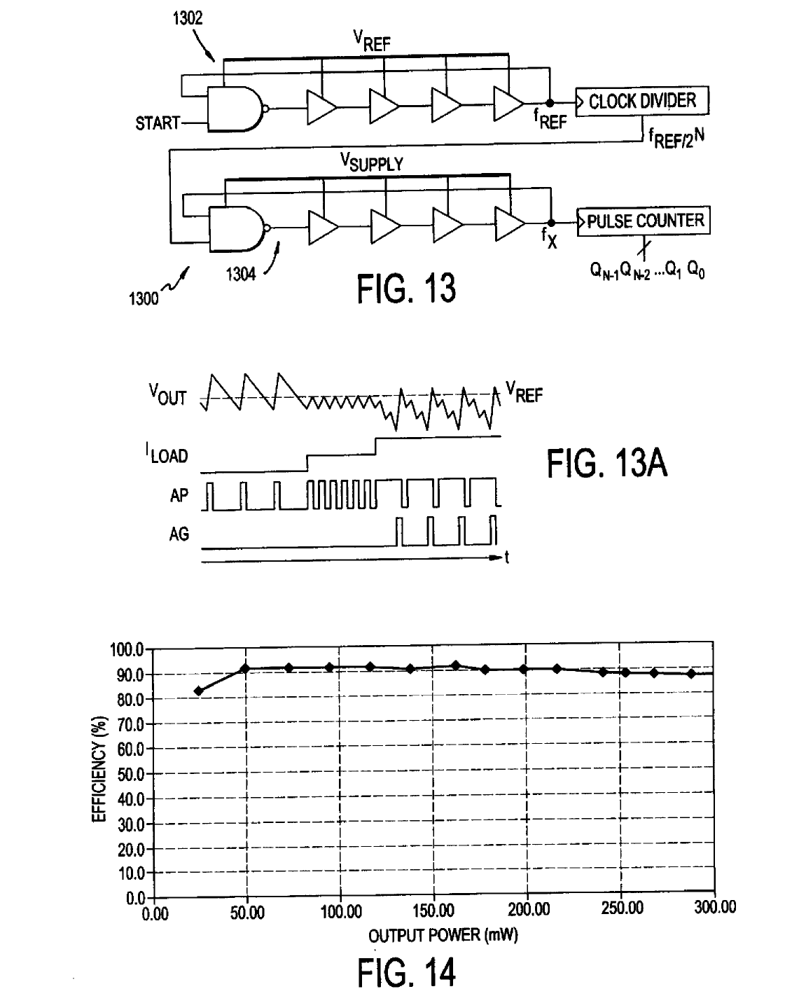

The aforementioned A/D converter is mainly used to detect and convert both line and load regulation errors for the controller. FIG. 13 shows the generic schematic of the sensor circuit 1300, including two stages 1302, 1304, each based on the A/D converter 1200 described above. Here, V_{SUPPLY} can be either V_{IN} or V_{OUT}. The upper ring oscillator, powered by V_{REF}, generates a reference clock signal with a frequency of f_{REF}. A clock divider then divides the frequency to produce f_{REF}/2. This is then used as the start signal for the ring oscillator that is powered by V_{SUPPLY}. When f_{REF}/2 is low, the ring oscillator is activated and the following pulse counter counts the number of pulse in that half clock period which is displayed as the counter output as (N−1)-bit binary signals Q_{N-1} . . . Q₀. If the two voltages are equal, they should have exactly the same number of pulses in that half clock period. Otherwise the number of pulses would be different as follows:

If V_{SUPPLY}>V_{REF},Q_{N-1} . . . Q₀>‘10 . . . 0’;

If V_{SUPPLY}=V_{REF},Q_{N-1} . . . Q₀=‘10 . . . 0’;

If V_{SUPPLY}<V_{REF},Q_{N-1} . . . Q₀>‘10 . . . 0’.

The AP control can also be implemented in different ways. One has just been disclosed. Another uses a comparator. The control scheme employed in this design is indeed a combination of adaptive gain (AG) and adaptive pulse (AP) control. Different GRs in the converter offer different charge and energy transference capabilities. The reconfiguration of the power stage allows us to exploit this feature to provide closed-loop control with high efficiency and fast transient response. However, employing AG control only faces one critical drawback: the durations of charge and discharge phases are fixed. In the steady state, if energy delivered in charge phase is much higher than the actual load demand, the converter has no ‘fine-tuning’ mechanism to make effective self-adjustment. As a result, the ripple voltages are high. In addition, at light load, the frequent switching actions dominate the entire power consumption and degrade the efficiency.

An adaptive pulse control will take into effect in this scenario. As shown in FIG. 13A, the controller in this case compares the actual V_{OUT} with the desired level of V_{REF} to determine the starting time and duration of the charge phase. At light load, the load has no urgent energy demand. The controller adaptively decreases the frequency of the pulse assignment. Switching loss of the converter is then reduced and the efficiency is maintained at a relatively high level. If the load has a sudden increase and the AP control cannot supply enough energy, the AG control will increase the value of GR to provide the extra current and energy immediately.

The reference voltage is an external input to the converter assuming the converter is used in DVS applications. However, if the output voltage is fixed for any application, the reference voltage can be generated on chip.

The proposed converter was designed and simulated with TSMC 0.35-μm digital CMOS N-well process. The efficiency of the power stage is shown in FIG. 14 for a 2/3 gain setting with an input voltage of 3.3V. The simulation is done in transistor level with HSPICE simulation software.

Any SC DC-DC converter performs by charging and discharging the pumping capacitor. After the discharge period, the voltage across the pumping capacitor decreases as charge is drained from it by the output. As a result, at the beginning of the charging period, the voltage across the capacitor suddenly increases. This results in a sudden inrush of current going into the capacitor. Now, the power source is connected to the converter via wires which includes parasitic inductance. Sudden increase in current creates voltage spikes across the wire which is then coupled into the power source.

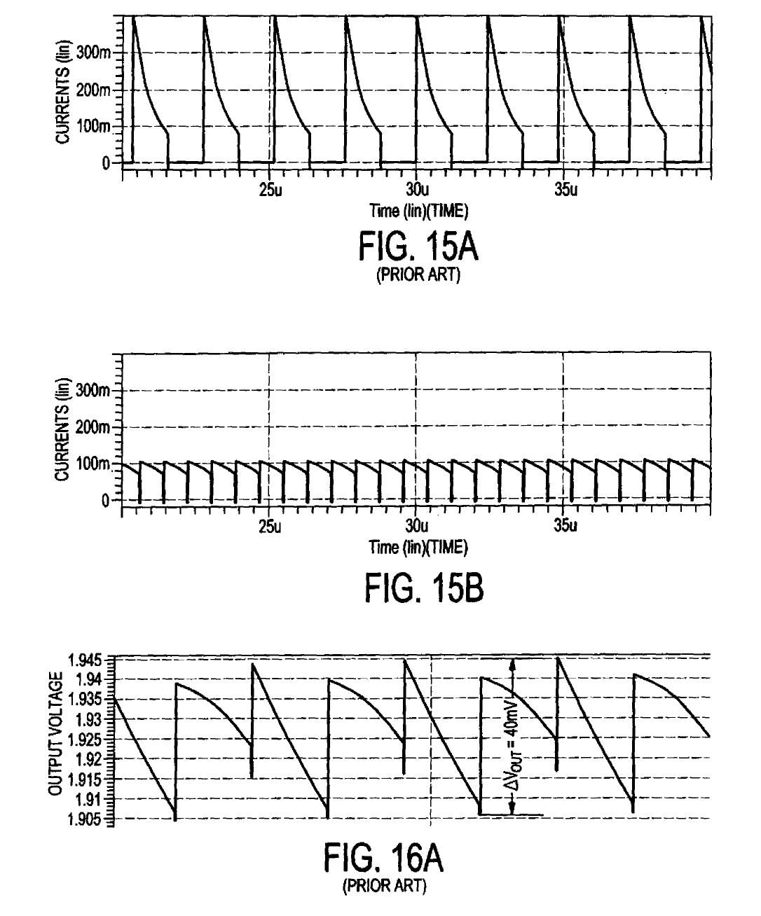

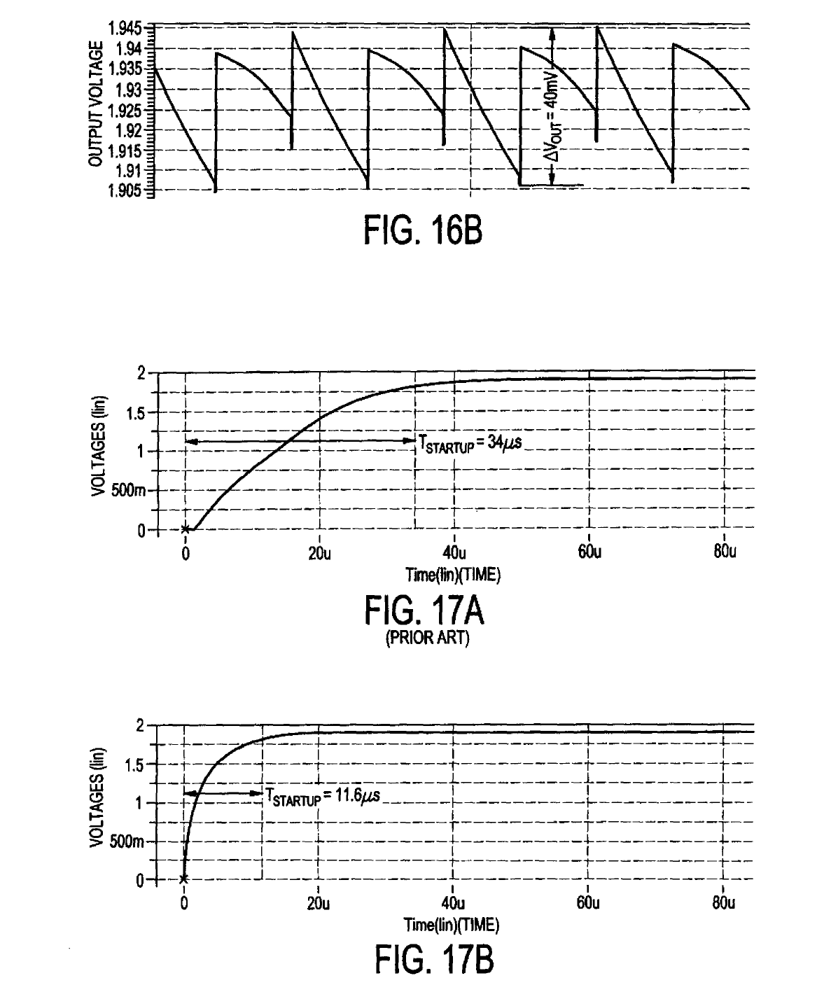

If the same power source is used in other parts of the system, this input noise gets coupled to those systems as well. The present invention reduces this effect by cycling the pumping capacitors to give a more continuous current. FIG. 15A shows the input current of a conventional SC DC-DC converter, and FIG. 15B shows the input current of the preferred embodiment. The input current waveform is simulated using the HSPICE simulation software under the same load and line condition. The switches are implemented using NMOS and PMOS transistors. As shown in the figures, inrush current is more stable for current technology as at least one pumping. The charge and discharge phenomenon also renders a large output ripple in a conventional SC converter. During the charging phase, the output load drains current from the output capacitor, reducing the voltage across the capacitor. In the preferred embodiment, there is at least one pumping capacitor that is discharging and delivering power to the output. This reduces the output ripple as shown in FIGS. 16A and 16B. FIG. 16A shows the output ripple of a conventional SC converter, and FIG. 16B shows the output ripple of the SC converter according to the preferred embodiment. The output ripple waveforms are generated under the same line and load condition.

FIGS. 17A and 17B show the start-up transient response of the conventional SC power stage and the preferred embodiment, respectively. The preferred embodiment has faster transient response than the conventional SC DC-DC converter. This is because in one period, there is three charge and discharge cycle by the converter whereas the conventional converter has only one charge and discharge cycle. As a result, the invented power stage can deliver power faster than conventional one. Again, the waveforms are obtained from HSPICE simulation under the same line and load condition.

While a preferred embodiment has been set forth in detail above, those skilled in the art who have reviewed the present disclosure will readily appreciate that other embodiments can be realized within the scope of the invention. For example, numerical values and fabrication techniques are illustrative rather than limiting. Therefore, the present invention should be construed as limited only by the appended claims.

We claim:

1. A DC-DC converter comprising:
(a) a voltage input;
(b) a voltage output;
(c) a ground;
(d) an output capacitor connected between the voltage output and the ground;
(e) a plurality of capacitors each having a top plate and bottom plate;
(f) for each of the capacitors:
(i) a first switch connected between the top plate of the capacitor and the voltage input;
(ii) a second switch connected between the top plate of the capacitor and the voltage output;
(iii) at least one of:
(A) a third switch connected between the voltage input and the bottom plate of the capacitor;
(B) a fourth switch connected between the bottom plate of the capacitor and the voltage output;
(iv) a fifth switch connected between the bottom plate of the capacitor and the ground; and
(v) a sixth switch connected between the top plate of the capacitor and the bottom plate of an another one of the plurality of capacitors such that each of the plurality of capacitors is connected to an adjacent one of the plurality of capacitors and such that a first one and a last one of the plurality of capacitors are connected; and
(g) a circuit for controlling the first through sixth switches for each of the plurality of capacitors in a plurality of clock phases such that during each of the clock phases, one of the plurality of capacitors is discharged at the voltage output while at least one other of the plurality of capacitors is charged from the voltage input, wherein the plurality of clock phases do not overlap.

2. The DC-DC converter of claim 1, wherein the circuit controls the first through sixth switches to select one of a plurality of voltage gains.

3. The DC-DC converter of claim 1, comprising at least three of said plurality of capacitors.

4. The DC-DC converter of claim 3, wherein the circuit controls the first through sixth switches to select one of a plurality of voltage gains.

5. The DC-DC converter of claim 4, wherein the at least three capacitors comprise first, second and third capacitors, and wherein:
for a gain ratio of 1/3, the first and second capacitors are connected in series between the voltage input and the voltage output, and the third capacitor is connected between the second capacitor and the ground;
for a gain ratio of 1/2, the first and second capacitors are connected between the voltage input and the ground, and the third capacitor is connected between the voltage output and the ground;
for a gain ratio of 2/3, the first capacitor is connected between the voltage input and the voltage output, and the second and third capacitors are connected in series between the first capacitor and the ground;
for a gain ratio of 1, the first and second capacitors are connected in parallel between the voltage input and the ground, and the third capacitor is connected between the voltage output and the ground;
for a gain ratio of 3/2, the first and second capacitors are connected in series between the voltage input and the ground, and the third capacitor is connected between the voltage input and the voltage output;
for a gain ratio of 2, the first and second capacitors are connected in parallel between the voltage input and the ground, and the third capacitor is connected between the first capacitor and the voltage output; and
for a gain ratio of 3, the first and second capacitors are connected in series between the voltage input and the ground, and the third capacitor is connected between the first capacitor and the voltage output.

6. The DC-DC converter of claim 1, further comprising an analog-to-digital converter connected to the voltage output.

7. The DC-DC converter of claim 6, wherein the analog-to-digital converter is a ring oscillator based analog-to-digital converter.

8. The DC-DC converter of claim 7, wherein the ring oscillator based analog-to-digital converter comprises:
a NOR gate;
a plurality of delay cells connected in series with an output of the NOR gate;
a feedback loop from an output of last one of the delay cells to the NOR gate; and
a pulse counter connected to the output of the last one of the delay cells;
wherein the NOR gate and the plurality of delay cells are powered from the voltage output.

9. The DC-DC converter of claim 1, wherein the circuit for controlling dynamically controls the switches.

10. An analog-to-digital converter for converting an analog signal to a digital signal, the analog-to-digital converter comprising:
a NOR gate;
a plurality of delay cells connected in series with an output of the NOR gate;
a feedback loop from an output of last one of the delay cells to the NOR gate; and
a pulse counter connected to the output of the last one of the delay cells;
wherein the NOR gate and the plurality of delay cells are powered by the analog signal.

11. A method for DC-DC conversion, the method comprising:
providing a DC-DC converter comprising:
(a) a voltage input;
(b) a voltage output;
(c) a ground;
(d) an output capacitor connected between the voltage output and the ground;
(e) a plurality of capacitors each having a top plate and bottom plate;
(f) for each of the capacitors:
(i) a first switch connected between the top plate of the capacitor and the voltage input;
(ii) a second switch connected between the top plate of the capacitor and the voltage output;
(iii) at least one of:
(A) a third switch connected between the voltage input and the bottom plate of the capacitor;
(B) a fourth switch connected between the bottom plate of the capacitor and the voltage output;
(iv) a fifth switch connected between the bottom plate of the capacitor and the ground; and
(v) a sixth switch connected between the top plate of the capacitor and the bottom plate of an another one of the plurality of capacitors such that each of the plurality of capacitors is connected to an adjacent one of the plurality of capacitors and such that a first one and a last one of the plurality of capacitors are connected; and
(g) a circuit for controlling the first through sixth switches for each of the plurality of capacitors in a plurality of clock phases such that during each of the clock phases, one of the plurality of capacitors is discharged at the voltage output while at least one other of the plurality of capacitors is charged from the voltage input, wherein the plurality of clock phases do not overlap;
controlling the switches, by use of the circuit for controlling, to select a gain ratio; and
operating the DC-DC converter to operate at the gain ratio selected.

12. The method of claim 11, wherein the DC-DC converter comprises at least three of said plurality of capacitors.

13. The method of claim 12, wherein the at least three capacitors comprise first, second and third capacitors, and wherein:
for a gain ratio of 1/3, the first and second capacitors are connected in series between the voltage input and the voltage output, and the third capacitor is connected between the second capacitor and the ground;
for a gain ratio of 1/2, the first and second capacitors are connected between the voltage input and the ground, and the third capacitor is connected between the voltage output and the ground;
for a gain ratio of 213, the first capacitor is connected between the voltage input and the voltage output, and the second and third capacitors are connected in series between the first capacitor and the ground;
for a gain ratio of 1, the first and second capacitors are connected in parallel between the voltage input and the ground, and the third capacitor is connected between the voltage output and the ground;
for a gain ratio of 3/2, the first and second capacitors are connected in series between the voltage input and the ground, and the third capacitor is connected between the voltage input and the voltage output;
for a gain ratio of 2, the first and second capacitors are connected in parallel between the voltage input and the ground, and the third capacitor is connected between the first capacitor and the voltage output; and
for a gain ratio of 3, the first and second capacitors are connected in series between the voltage input and the ground, and the third capacitor is connected between the first capacitor and the voltage output.

14. The method of claim 11, wherein the step of controlling is performed dynamically.
